(19) United States
(12) Patent Application Publication
(10) Pub. No.: US 2018/0139050 A1
(43) Pub. Date: May 17, 2018

(54) Wireless identification device, system, and method of interactive product authentication for smart advertisement enabled anti-counterfeit package

(71) Applicant: Silicon Craft Technology Co., Ltd., Bangkok (TH)

(72) Inventors: Suradeth Aroonsantidecha, Bangkok (TH); Thanapol Hongsongkiat, Bangkok (TH); Peera Thontirawong, Bangkok (TH)

(21) Appl. No.: 15/812,563

(22) Filed: Nov. 14, 2017

(30) Foreign Application Priority Data
Nov. 15, 2016 (TH) 1601006847

(51) Int. Cl. H04L 9/32; G08B 13/24; H04W 4/00; G06Q 30/02

(52) U.S. Cl. CPC H04L 9/3234; G08B 13/2428; H04L 9/3226; H04L 2209/805; G06Q 30/0238; B65D 2101/00; H04W 4/008

(57) ABSTRACT

The present disclosure relates, according to some embodiments, to product authentication systems comprising a wireless identification device including a memory, a tamper evident detection circuit, and an electrically conductive circuit. The product authentication system may be configured to provide marketing information to the authentic wireless identification device. The wireless identification device may be configured to generate a rolling code with respect to at least one event field relating to wireless communication, to generate a tamper activated seed when the tamper evident detection circuit detects a change in at least one electrical property of the electrically conductive circuit, and to provide the wireless communication device with an NDEF message.

### CROSS-REFERENCE TO RELATED APPLICATIONS

This application claims priority to Thai Patent Application No. 1601006847 filed on Nov. 15, 2016. The contents of all of the above are hereby incorporated in their entirety by reference.

### FIELD OF THE DISCLOSURE

The present disclosure relates to wireless identification devices, systems, and methods of using short range communication for secret or secure communication and for verifying the identity or entity authentication, specially adapted for advertisement effectiveness.

| | |
|---|---|
| G06K19/07 | Data carriers, such as smart cards or RFID tags that |
| | comprise at least one integrated circuit |
| G06Q30/0242 | Data processing systems or methods specially adapted for |
| | advertisement effectiveness |
| G08B13/14 | This group relates to subject matter in which the |
| | (attempted) physical removal of an object is detected. |
| H04W4/008 | Electric communication technique using short range |
| | communication |
| H04L9/32 | Electric communication technique for secret or secure |
| | communication including means for verifying the identity |
| | or entity authentication |

Note:
Tentative classifications should be G06K19/07; G06Q30/0242; G08B13/14; H04W4/008; H04L9/32.

### BACKGROUND OF THE DISCLOSURE

Counterfeiting is a rapidly growing worldwide problem attributable in part to a rapid growth of world trade and e-commerce. It increases several concerns regarding brand awareness and the impact of counterfeit products on the brand image of authentic products. Recently, consumers and even market surveillance have limited competence to detect counterfeit products and have difficulty identifying whether information on a particular seller or product is accurate. These issues have promoted the development of anti-counterfeit packaging for brand protection. Among several promising technologies, RFID plays an increasingly important role as a security countermeasure for counterfeiting, theft, and tampering of product packaging.

RFID technology has considerable potential in product authentication. The benefits of RFID include non-line-of-sight reading, item-level identification, non-static nature of security features, and cryptographic resistance. The product authentication based on RFID technology provides not only brand owners and retailers, but also consumers, with a way to verify whether a product is authentic. This capability has real benefits to brand owners, retailers, and consumers in an industry where product counterfeiting is increasingly prevalent.

In addition to providing a way to protect consumers from buying fake goods, retailers and brand owners may also encourage consumers to purchase their authentic products by providing special treatment, promotions, and vouchers through their product packaging. Retailers and brand owners may offer their consumers an “interactive experience” by smart advertisement. It is important for smart advertisements to make consumers engage more interactively in marketing campaigns. Effective marketing strategies stand to elevate a brand position in the consumers' minds through consumer participation. Campaigns that provide an incentive for participation, especially, are a great way to engage a consumer while minimizing the chance that he or she will consider your promotion annoying and invasive.

Both product authentication and smart advertisements, the two distinct functions, together can enhance a brand by assisting sales and by protecting the authentic product. For example, consumers may get a voucher or discount at the point of purchase when the seller or the consumer activates the product authentication by tearing the label embedded with a wireless identification device having a tamper evident detection circuit. The design, system, equipment, and method of an interactive product authentication for use in smart advertisement should be user-friendly, easy to manage, and highly secure.

Therefore, the present disclosure provides for product authentication systems for anti-counterfeit packaging, the benefits of which may include: the cost and required effort to perform a check is low; no additional software or computer program needs to be installed in the user's wireless communication device; automatic notification of tamper-evident detection in which at least some wireless identification device functions are activated or removed after tampering; prevention of cloning attacks and replay attacks; and an appropriate level of security for the transmitted data.

The disadvantages of current wireless identification devices and system designs are that they either do not resolve the aforementioned issues or do provide the combination of these unique features but in a complex and expensive design. Thus, the present disclosure provides for product authentication systems for anti-counterfeit packaging for improving and modifying interactive product authentication systems to support both an entity authentication and smart advertisement features.

### SUMMARY

The present disclosure relates to product authentication systems that may comprise a wireless identification device including a memory, a tamper evident detection circuit, and an electrically conductive circuit. In some embodiments, the product authentication system may be configured to provide marketing information to the authentic wireless identification device.

According to some embodiments, the wireless identification device may be configured to generate a rolling code with respect to at least one event field relating to wireless communication. The wireless identification device may also be configured to generate a tamper activated seed when the tamper evident detection circuit detects a change in at least one electrical property of the electrically conductive circuit, and provide the wireless communication device with a message.

According to some embodiments, a message may include or exclude a rolling code based on the value of the tamper activated seed.

In some embodiments, a product authentication system may comprise a wireless identification device, a wireless communication device for communicating with a wireless identification device and a server. The server may be configured to provide content to the wireless communication device.

According to some embodiments, a wireless communication device may be configured to receive an NDEF message from the wireless identification device.

According to some embodiments, a server may be configured to determine whether the wireless identification device is authentic by comparing at least one rolling code stored in a wireless identification device and at least one rolling code stored in a server. The server may send a message comprising a web-address linked to marketing information when the wireless identification device is authentic, or otherwise, the server may stop communicating with the wireless communication device.

According to some embodiments, an NDEF message may include a web-address of the server and an identifier value of the wireless identification device.

According to some embodiments, a server may be configured to determine whether the wireless identification device is authentic by verifying that the rolling code value received from the wireless identification device is equal to the rolling code stored in the server, and concluding that the wireless identification device is authentic.

According to some embodiments, the product authentication system may access the web-address indicating the identifier value of the wireless identification device and indicate that the wireless identification device has been accessed. The web-address may be accessed by the wireless communication device.

In some embodiments, a product authentication system may comprise a wireless identification device and a wireless communication device for communicating with a wireless identification device.

According to some embodiments, a wireless communication device may be configured to determine whether a wireless identification device is authentic by comparing at least one rolling code stored in a wireless identification device and at least one rolling code stored in a wireless communication device. In some embodiments, when the wireless identification device is authentic, the wireless communication device may convey data comprising the web-address linked to marketing information, or otherwise, the wireless communication device may be configured to stop communicating with the wireless identification device.

According to some embodiments, a wireless communication device may be configured to determine whether the wireless identification device is authentic by verifying that the rolling code value received from the wireless identification device is equal to the rolling code stored in the wireless communication device. The wireless communication device may then conclude that the wireless identification device is authentic.

According to some embodiments, at least one event field relating to wireless communication may comprise receiving a dedicated command from a wireless communication device.

According to some embodiments, a tamper activated seed may be a marker stored via memory. The marker may be indicative of a tampering status.

According to some embodiments, a rolling code may be generated by calculating the forward rolling code.

According to some embodiments, marketing information may comprise a voucher or a coupon.

According to some embodiments, an electrically conductive circuit may comprise at least one circuit line.

According to some embodiments, at least one property of the electrically conductive circuit may be electrical impedance.

### BRIEF DESCRIPTION OF THE DRAWINGS

Non-limiting embodiments of the present disclosure will be described by way of example with reference to the accompanying figures, which are schematic and are not intended to be drawn to scale.

FIG. 1 illustrates schematics of a product authentication system according to a specific example embodiment of the present disclosure;

FIG. 2 illustrates an example of an NDEF message comprising NDEF records stored in the device's memory according to a specific example embodiment of the present disclosure; and

FIG. 3 illustrates an operating process of a product authentication system according to a specific example embodiment of the present disclosure.

Various objects, features, aspects, and advantages of the present disclosure will become more apparent from the following detailed description of preferred embodiments of the disclosure, along with the accompanying drawings in which like numerals represent like components. The figures provided are not intended to be exhaustive or to limit the disclosure to the precise forms disclosed. Many modifications and variations will be apparent to one of ordinary skill having the benefit of the present disclosure. The embodiments were chosen and described in order to best explain the principles of the present disclosure and its partial application, thereby enabling others skilled in the art to understand the disclosure for various embodiments and with various modifications that are suited to the particular use contemplated.

### DETAILED DESCRIPTION OF PREFERRED EMBODIMENTS

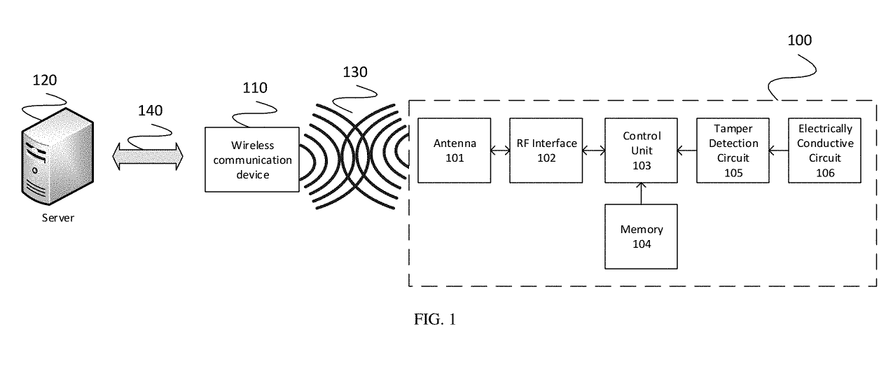

FIG. 1 illustrates schematics of a product authentication system according to a specific example embodiment of the present disclosure. As shown, an example embodiment of the present disclosure may comprise a wireless identification device 100, a wireless communication device 110, and a server unit or server 120. The wireless identification device 100 may comprise an antenna 101, an RF interface 102, a control unit 103, a memory 104, a tamper evident detection circuit 105, and an electrically conductive circuit 106. The wireless communication device 110 may be configured to communicate with the wireless identification device 100 through interrogation signal 130 and with the server 120 through a network 140. The wireless communication device 110 may be configured to receive an NDEF message from the wireless identification device 100. The server 120 may be configured to provide content to the wireless communication device 110.

The wireless identification device 100 may be configured to generate a rolling code (RLC) with respect to at least one event field relating to wireless communication. The wireless identification device 100 may also be configured to generate a tamper activated seed when the tamper evident detection circuit 105 detects a change in at least one electrical property of the electrically conductive circuit 106. The wireless identification device 100 may also be configured to provide the wireless communication device 110 with an NDEF message. The tamper activated seed may be a marker that is stored in the memory. The marker may be indicative of the tampering status

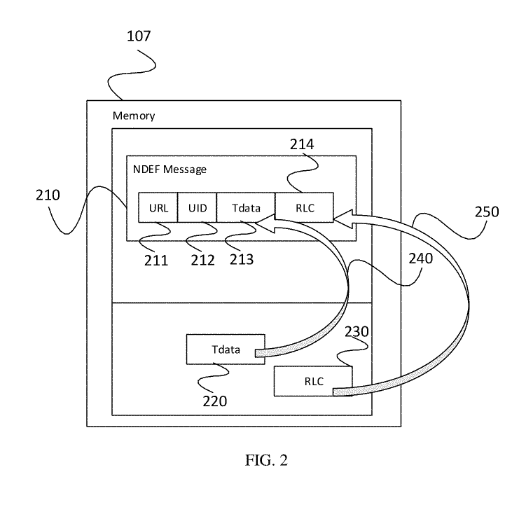

FIG. 2 illustrates an example of an NDEF message 210 comprising an NDEF record stored in the memory 107. The NDEF message 210 may contain payloads of data comprising a web-address of the server (URL) 211, an identifier value of the wireless identification device (UID) 212, a Tamper status (Tdata) 213, and a rolling code (RLC) 214. In some embodiments, the rolling code (RLC) 214 may be generated by calculating the forward rolling code.

The RLC 214 may be generated by step 250 of mirroring an RLC 230 stored in another part of the memory into the NDEF message 210. The NDEF message 210 may be configured to include or exclude the RLC 214 depending on the value of tamper activated seed.

The Tdata 213 may be generated by step 240 of mirroring a predefined Tdata 220 stored in another part of the memory into the NDEF message. The Tdata 213 may indicate a “purchased” status, retailer name, or campaign name.

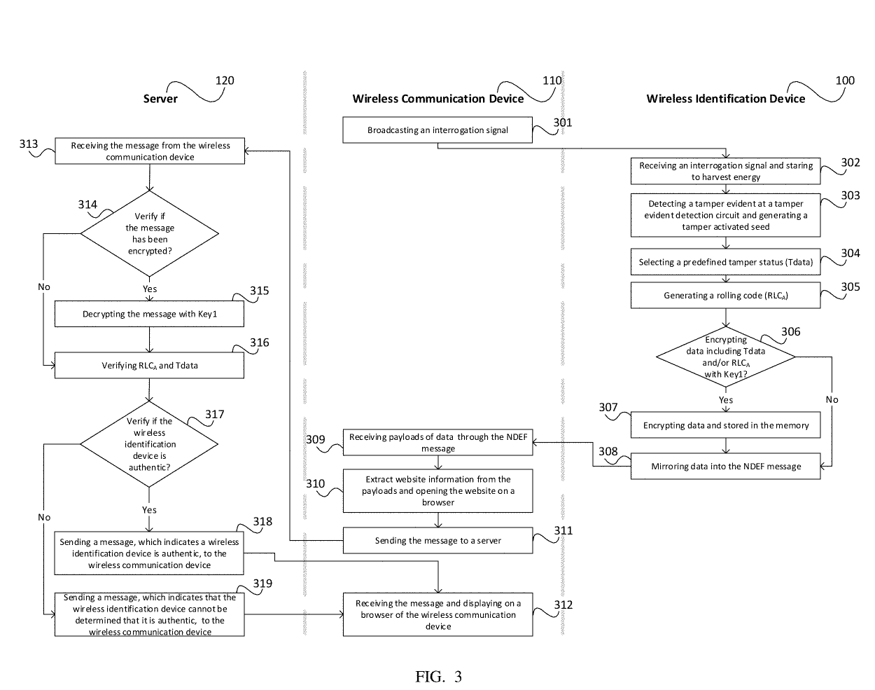

FIG. 3 illustrates an operating process of a product authentication system according to a specific example embodiment of the present disclosure. In some embodiments, the process may start when the wireless communication device 110 broadcasts an interrogation signal, as indicated by step 301. The wireless identification device 100 may receive the interrogation signal and starts to harvest energy, as indicated by step 302. When the wireless identification device 100 is woken-up, it may begin tamper detection at a tamper evident detection circuit and generate (or update) a tamper activated seed, as indicated by step 303.

The tamper evident detection circuit 105 may generate (or update) a tamper activated seed when the tamper evident detection circuit 105 detects a change in at least one electrical property of the electrically conductive circuit 106. The electrically conductive circuit 106 may comprise at least one circuit line. At least one property of the electrically conductive circuit is electrical impedance. The change in at least one electrical property of the electrically conductive circuit 106 may occur when the electrically conductive circuit 106 is damaged by tearing or cutting.

In some embodiments, the wireless identification device 100 may then select a predefined tamper status (Tdata) depending on the value of the tamper activated seed, as indicated by step 304. The wireless identification device 100 may generate a rolling code (RLC_{A}) with respect to at least one event field relating to wireless communication. An event field may include receiving a dedicated command from the wireless communication device 110, as indicated by step 305. The Tdata 220 and RLC_{A} 230 may be encrypted and stored in the device's memory 307. The Tdata 220 and RLC_{A} 230, whether encrypted or not, may be mirrored into the NDEF message, as indicated by step 308.

According to step 309, the wireless communication device 110 may receive an NDEF message containing payloads of data from the wireless identification device 100. Then, the wireless communication device 110 may extract website information from the message and opens the website, as indicated by step 310. The wireless communication device 110 may access the web-address indicating the identifier value of the wireless identification device 100 and indicate that the wireless identification device has been accessed. In the following step 311, the wireless communication device 110 may send a message to the server 120. The message sent may include the wireless identification device 212, the Tdata 213, and the RLC 214.

Once the server 120 receives the message from the wireless communication device 110, the server 120 may verify whether any part of the message is encrypted. In the case that the message is encrypted, the server 120 may decrypt the message with Key1 stored at the server 120. According to step 317, the server 120 may be configured to determine whether the wireless identification device 100 is authentic by verifying that the RLC value received from the wireless identification device 100 is equal to the RLC stored in the server 120, and concluding that the wireless identification device 100 is authentic.

In the case that the wireless identification device 100 is authentic according to step 318, the server 120 may send a message comprising a web-address linked to marketing information and data indicating that the wireless identification device 100 is authentic. Otherwise, the server 120 may send a message indicating that server 120 could not determine whether the wireless identification device 100 is authentic according to step 319. In some embodiments, the server 120 may stop communicating with the wireless communication device 110.

Regardless of whether the wireless identification device 100 is authentic, the wireless communication device 110 may receive the message from the server 120 to display on the screen of the wireless communication device 110, according to step 312. A user may then decide what to do next according to the displayed information.

According to some embodiments of the present disclosure, there may be no need to install a specific computer program or software in the wireless communication device 110. The wireless communication device 110 may act as an intermediary to send the information from the wireless identification device 100 to the server 120 and the server 120 can display a reply on the general browser of the wireless communication device 110.

According to some embodiments of the present disclosure, there may be no serve included with a product authentication system. In embodiments where there is no server included in the product authentication system, the wireless communication device may be configured to work in place of the server. Specific computer programs or software may need to be installed before it can work as a substitute for the server. In this case, the wireless communication device can determine whether the wireless identification device is authentic and provide the information related to the marketing information to the user through the general browser of the wireless communication device.

As will be understood by those skilled in the art who have the benefit of the instant disclosure, other wireless identification devices, methods, and systems can be envisioned without departing from the description contained herein. Accordingly, the manner of carrying out the disclosure as shown and described is to be construed as illustrative only. Persons skilled in the art having the benefit of the present disclosure may make various changes without departing from the scope of the instant disclosure.

Where the verb “may” appears, it is intended to convey an optional and/or permissive condition, but its use is not intended to suggest any lack of operability unless otherwise indicated. Where open terms such as “having” or “comprising” are used, one of ordinary skill in the art having the benefit of the instant disclosure will appreciate that the disclosed features or steps optionally may be combined with additional features or steps.

The title, abstract, background, and headings are provided in compliance with regulations and/or for the convenience of the reader. They include no admissions as to the scope and content of prior art and no limitations applicable to all disclosed embodiments.

1. A product authentication system, comprising:
a wireless identification device comprising a memory, a tamper evident detection circuit, and an electrically conductive circuit,
wherein the wireless identification device generates a rolling code with respect to at least one event field relating to wireless communication,
wherein the wireless identification device generates a tamper activated seed when the tamper evident detection circuit detects a change in at least one electrical property of the electrically conductive circuit,
wherein the wireless identification device is configured to provide the wireless communication device with an NDEF message, and
wherein the NDEF message includes or excludes a rolling code based on the value of tamper activated seed;
a wireless communication device configured to receive the NDEF message from the wireless identification device;
a server for providing content to the wireless communication device,
wherein the server is configured to determine whether the wireless identification device is authentic by comparing at least one rolling code stored in the wireless identification device and at least one rolling code stored in the server.

2. The product authentication system of claim 1, wherein the server sends data comprising a web-address linked to marketing information if the wireless identification device is authentic, or, if not, the server stops communicating with the wireless communication device.

3. The product authentication system of claim 1, wherein the NDEF message includes a web-address of the server and an identifier value of the wireless identification device.

4. The product authentication system of claim 1, wherein a server is configured to determine whether the wireless identification device is authentic by verifying that the rolling code value received from the wireless identification device is equal to the rolling code stored in the server, and concluding that the wireless identification device is authentic.

5. The product authentication system of claim 1, wherein the wireless communication device accesses the web-address indicating the identifier value of the wireless identification device and indicates that the wireless identification device has been accessed.

6. A product authentication system, comprising:
a wireless identification device comprising a memory, a tamper evident detection circuit, and an electrically conductive circuit,
wherein the wireless identification device generates a rolling code when at least one event field relating to wireless communication,
wherein the wireless identification device generates a tamper activated seed when the tamper evident detection circuit detects a change in at least one electrical property of the electrically conductive circuit,
wherein the wireless identification device is configured to provide the wireless communication device with a message, and
wherein the message includes or excludes a rolling code based on the value of tamper activated seed;
a wireless communication device for communicating with a wireless identification device,
wherein the wireless communication device is configured to determine whether the wireless identification device is authentic by comparing at least one rolling code stored in a wireless identification device and at least one rolling code stored in the wireless communication device.

7. The product authentication system of claim 6, wherein the wireless communication device conveys data comprising a web-address linked to marketing information if the wireless identification device is authentic, or if not, the wireless communication device stops communicating with the wireless identification device.

8. The product authentication system of claim 6, wherein the wireless communication device is configured to determine whether the wireless identification device is authentic by verifying that the rolling code value received from the wireless identification device is equal to the rolling code stored in the wireless communication device, and concluding that the wireless identification device is authentic.

9. The product authentication system of claim 1, wherein the electrically conductive circuit comprises at least one circuit line.

10. The product authentication system of claim 1, wherein at least one property of the electrically conductive circuit is electrical impedance.

11. The product authentication system of claim 1, wherein at least one event field relating to wireless communication comprises receiving a dedicated command from a wireless communication device.

12. The product authentication system of claim 1, wherein the tamper activated seed is a marker stored in the memory which is indicative of the tampering status.

13. The product authentication system of claim 6, wherein the electrically conductive circuit comprises at least one circuit line.

14. The product authentication system of claim 6, wherein at least one property of the electrically conductive circuit is electrical impedance.

15. The product authentication system of claim 6, wherein at least one event field relating to wireless communication comprises receiving a dedicated command from a wireless communication device.

16. The product authentication system of claim 6, wherein the tamper activated seed is a marker stored in the memory, wherein the marker is indicative of the tampering status.
